(19) United States
(12) Patent Application Publication
(10) Pub. No.: US 2025/0202314 A1
(43) Pub. Date: Jun. 19, 2025

(54) RESISTANCE WELDED ASSEMBLY FIXTURE

(71) Applicant: American Axle & Manufacturing, Inc., Detroit, MI (US)

(72) Inventors: Cory J. Padfield, Royal Oak, MI (US); Daniel A. Vanhaitsma, Royal Oak, MI (US); Samer Metry, Sterling Heights, MI (US); Toby V. Padfield, Livonia, MI (US)

(21) Appl. No.: 18/539,738

(22) Filed: Dec. 14, 2023

(51) Int. Cl. H02K 7/00; F16C 3/02

(52) U.S. Cl. CPC H02K 7/003; F16C 3/023

(57) ABSTRACT

A vehicular output shaft assembly, configured for a rotating electrical machine, including an elongated tubular shaft having a cavity at least partially defined by an inner diameter of the elongated tubular shaft and a shaft radial surface; an output coupling having an inner diameter and a coupling radial surface; and an integrated ring received within the cavity of the elongated tubular shaft and the inner diameter of the output coupling, wherein the integrated ring positions the shaft radial surface and the coupling radial surface to abut and the elongated tubular shaft and the output coupling are welded together between the shaft radial surface and the coupling radial surface.

### TECHNICAL FIELD

The present application relates to welded assemblies and, more particularly, to resistance welded assemblies.

### BACKGROUND

Output shafts of rotating electrical machines can include a number of components joined together. These components can include a drive shaft that is resistance welded to an output coupling, such as a gear or a splined shaft. The alignment of these components during the welding process can be important to ensure a balanced shaft. In the past, the components can be positioned against each other during the welding process. However, a chance exists that the components can be slightly offset from each other leading to vibrations as the angular velocity of output shafts increases, such as can occur when the rotating electrical machines are used in a battery electric vehicle. It would be helpful to increase the accuracy with which the components of the drive shaft can be welded using resistance welding.

### SUMMARY

In one implementation, a vehicular output shaft assembly, configured for a rotating electrical machine, including an elongated tubular shaft having a cavity at least partially defined by an inner diameter of the elongated tubular shaft and a shaft radial surface; an output coupling having an inner diameter and a coupling radial surface; and an integrated ring received within the cavity of the elongated tubular shaft and the inner diameter of the output coupling, wherein the integrated ring positions the shaft radial surface and the coupling radial surface to abut and the elongated tubular shaft and the output coupling are welded together between the shaft radial surface and the coupling radial surface.

In another implementation, a vehicular output shaft assembly, configured for a rotating electrical machine, includes an integrated ring having an outer surface configured to be received within a cavity of the elongated tubular shaft and an inner diameter of the output coupling, wherein the integrated ring positions a shaft radial surface and a coupling radial surface to abut facilitating a welded connection between the elongated tubular shaft and the output coupling between the shaft radial surface and the coupling radial surface.

### BRIEF DESCRIPTION OF THE DRAWINGS

FIG. 1 is a perspective view depicting an implementation of an output shaft assembly having an integrated ring;

FIG. 2 is a cross-sectional view depicting an implementation of an output shaft assembly having an integrated ring;

FIG. 3 is a cross-sectional view depicting a portion of an implementation of an output shaft assembly having an integrated ring;

FIG. 4 is a perspective view depicting an implementation of an integrated ring;

FIG. 5 is a perspective view depicting another implementation of an output shaft assembly having an integrated ring; and

FIG. 6 is a cross-sectional view depicting another implementation of an output shaft assembly having an integrated ring.

### DETAILED DESCRIPTION

An output shaft assembly can include an elongated tubular shaft that is positioned relative to an output coupling by a concentrically-received integrated ring to ensure accurate alignment both during and after the components are resistance welded together. The ring can be annularly- or disk-shaped and received within a cavity within the output coupling as well as a cavity within the tubular shaft. The fixture may remain in the output shaft assembly after welding thereby becoming a component in the output shaft assembly. Given the concentric location of the fixture and its position concentric with an axis of output shaft rotation, the fixture does not add significant load to the output shaft assembly.

In the past, output shafts have been mechanically held in an abutting relationship with the output coupling using a removable apparatus that held the components in place while they are resistance welded. And while the arrangement produced output shaft assemblies that were acceptable, the run out can be noticeable when the assemblies are used with rotating electrical machines that can rotate output shafts at elevated angular velocities. In contrast, output shaft assemblies that are resistance welded with the integrated fixture have less runout than if resistance welded using the removable apparatus.

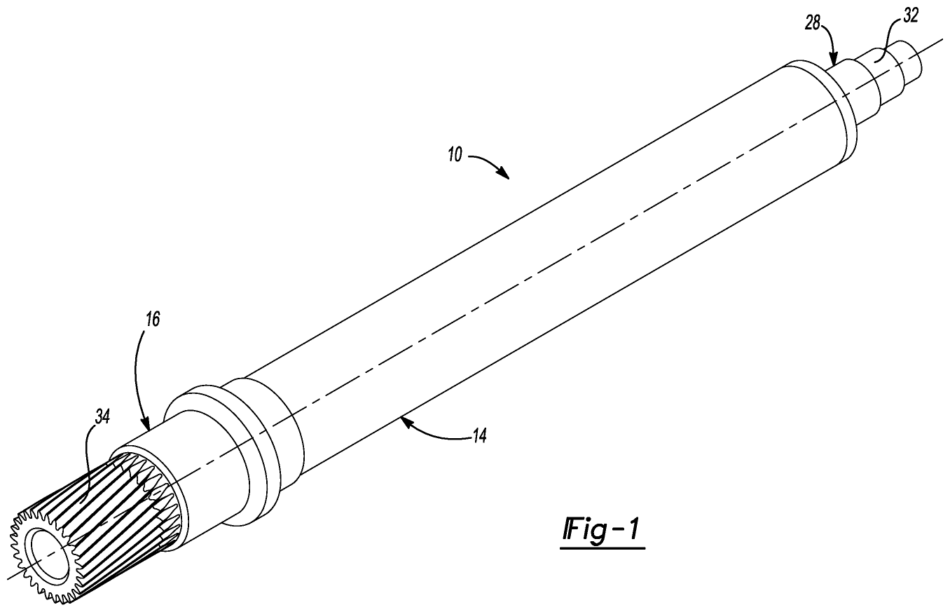

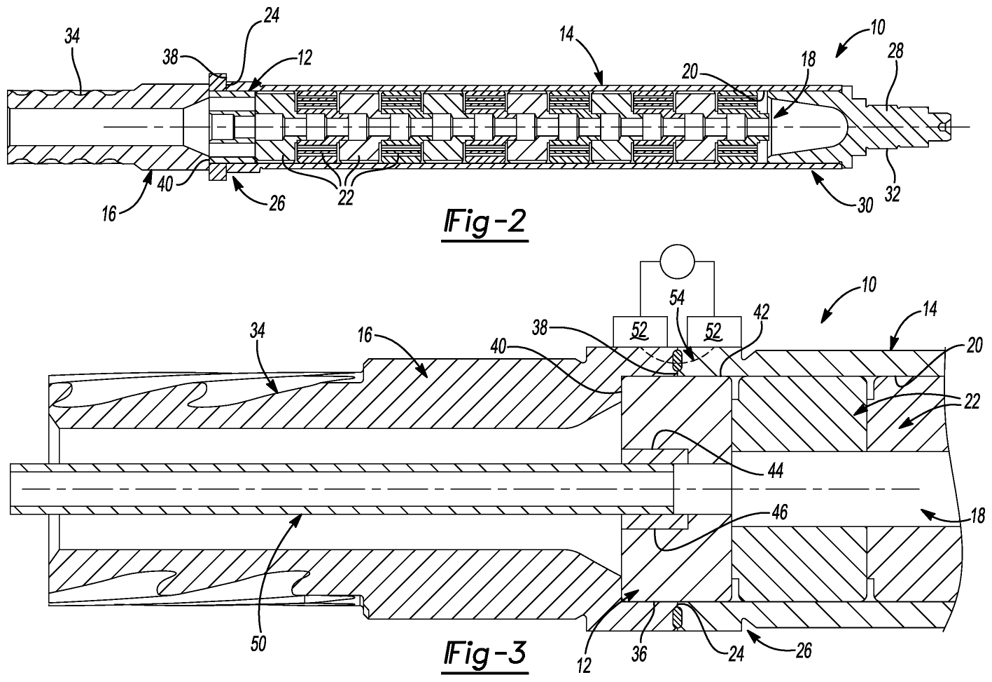

Turning to FIGS. 1-3, an implementation of an output shaft assembly 10 is shown having an integrated ring 12 that aligns an elongated tubular shaft 14 relative to an output coupling 16. The elongated tubular shaft 14 can have a cavity 18 that is defined by an inner diameter 20 of the shaft 14 and includes an axis of shaft rotation (x). The cavity 18 can be sized and shaped to receive a plurality of heat sinks 22 during assembly. The heat sinks 22 can be made from a heat conducting material, such as aluminum. A cross-sectional profile of the elongated tubular shaft 14 can be substantially circular. The elongated tubular shaft 14 includes a shaft radial surface 24 at a proximal end 26 between the inner diameter and an outer diameter of the shaft 14 that may have projections facilitating the creation of a resistance weld between the shaft 14 and the output coupling 16. The elongated tubular shaft 14 can be formed from cast or powdered metal. For instance, the elongated tubular shaft 14 can be formed from medium carbon steel, or from powdered metal that can be placed in a mold and heated until the shaft is a unitary structure. In one implementation, the elongated tubular shaft 14 can be formed from high-strength low-alloy (HSLA) steel. The elongated tubular shaft 14 can be received by or coupled to a rotor (not shown) of a rotating electrical machine.

The rotating electrical machine, also referred to as an electric motor, can be implemented as a permanent magnet synchronous electrical machine. The rotating electrical machine can be used as partial or sole propulsion for a battery electric vehicle (BEV). The term “battery electric vehicle” or “BEV” can refer to vehicles that are propelled, either wholly or partially, by rotating electrical machines or motors. BEV can refer to electric vehicles, plug-in electric vehicles, hybrid-electric vehicles, and battery powered vehicles.

A bearing cap 28 can be received at a distal end 30 of the elongated tubular shaft 14. The bearing cap 30 can include one or more bearing surfaces 32 that are received by the rotating electrical machine and support the elongated tubular shaft 14 during operation. The bearing cap 32 can be coupled to the elongated tubular shaft 32 in any one of a variety of different ways. For example, the bearing cap 32 can be mechanically secured to the elongated tubular shaft 14 to prevent the axial or angular displacement of the cap 32 relative to the shaft 14. In one implementation, the bearing cap 32 can be press fit into the cavity 18 of the elongated tubular shaft 14.

The output coupling 16 can transmit torque from the output shaft assembly 10 to a transmission (not shown) that communicates rotational movement to one or more drive wheels of the BEV. For example, the output coupling 16 shown in this embodiment includes a helical gear 34 and has an inner diameter 36 sized and shaped to receive the integrated ring 12. The output coupling 16 can be formed from powdered metal that is placed in a mold having the desired shape of the output coupling 16. The mold can then be heated so that the powdered metal hardens into a unitary element. The output coupling 16 also includes a coupling radial surface 38 that can be positioned so that the coupling radial surface 38 abuts the shaft radial surface 24. An annular shoulder 40 can extend radially-inwardly from the inner diameter 36 of the output coupling 16 to axially position the integrated ring 16 relative to the output coupling 16. The surfaces 24, 38 can be maintained in this relationship during welding by the integrated ring 12.

The integrated ring 12, shown in FIG. 4, can be an annular fixture that is slidably received within the cavity 18 of the elongated tubular shaft 14 and the inner diameter 36 of the output coupling 16 so that the radial surfaces 24, 36 of the shaft 14 and the coupling 16 abut. The integrated ring 12 can include a smooth outer diameter surface that is sized and shaped so that the surface closely fits into the cavity and the inner diameter 36 of the output coupling 16. In some implementations, the integrated ring 12 includes an outer diameter 42 that is slightly larger than the inner diameter 36 of the output coupling 16, the inner diameter 20 of the elongated tubular shaft 14, or both the shaft 14 and the coupling 16, such that the ring 12 is press-fit or interference-fit into the coupling 16 and/or the shaft 14. The integrated ring 12 can be electrically isolated from the elongated tubular shaft 14 and the output coupling 16 during the welding process. It is possible to accomplish this electrical isolation in any one of a variety of different ways. For example, an insulating coating can be applied to a surface of the ring 12, a surface of the tubular shaft 14, and/or a surface of the output coupling 16 prior to assembly. The insulating coating can be implemented using a polymeric powdercoat, such as Nylok Nyshield, or a fluorocarbon masking, such as Nylok Nycote. However, it should be appreciated that different insulating coatings could be successfully used.

The integrated ring 12 can include an inner diameter 44 that is sized to receive a bushing 46. The inner diameter 44 of the integrated ring 12 can be supported by a plurality of spokes 48 extending radially outwardly from the inner diameter 44 towards the outer diameter 42 of the integrated ring 12. The bushing 48 can be press-fit into the inner diameter 44 of the integrated ring 12 and sized to receive a distal end of a cooling tube 50 capable of flowing cooling fluid through the elongated tubular shaft 14. The bushing 46 can also radially locate the cooling tube 50 within the cavity 18 relative to the elongated tubular shaft 14. The integrated ring 12 can be formed from powdered metal that is placed in a mold having the desired shape of the ring 12. The mold can then be heated so that the powdered metal hardens into a unitary element. The integrated ring 12 can be formed from a metal that does not create a resistance weld path at the site of the weld. It should be appreciated that the term “integrated ring” can be used interchangeably with the term “integrated fixture” and that an integrated ring can be shaped into a variety of different forms. For example, an integrated ring can be disk shaped such that the area between the inner diameter and the outer diameter is substantially solid. Also, it should be appreciated that an integrated ring can be implemented without a cooling tube.

The output shaft assembly 10 can be completed by inserting the integrated ring 12 into the inner diameter 36 of the output coupling 16 such that the ring 12 is press fit within the inner diameter 36. The integrated ring 12 can be press fit into the inner diameter 36 until it abuts the annular shoulder 40 such that an interference prevents the integrated ring 12 from axial or angular movement relative to the output coupling 16. The integrated ring 16 can be slidably received within the cavity 18 of the elongated tubular shaft 14 so that the coupling radial surface 38 abuts the shaft radial surface 24. The coupling radial surface 38 or the shaft radial surface 24 may include protrusions that extend away from the surface 24, 38 and can facilitate resistance welding. Welding electrodes can be positioned on an outer surface of the output coupling 16 and an outer surface of the elongated tubular shaft 14 adjacent to the abutting radial surfaces 24, 38. A resistance welding apparatus (not shown) can flow electrical current through the welding electrodes 52 thereby creating a weld path 54 between the output coupling 16 and the elongated tubular shaft 14. The weld path 54 may not pass through the integrated ring 12. The protrusions (if present) are melted and become part of the weld. After welding the output coupling 16 to the elongated tubular shaft 14 via resistance welding, the integrated ring 12 remains held within the output shaft assembly 12. The heat sinks 22 can be received within the cavity 18 of the elongated tubular shaft 14 and the integrated ring 12 can prevent axial movement of the heat sinks 22 within the shaft 14.

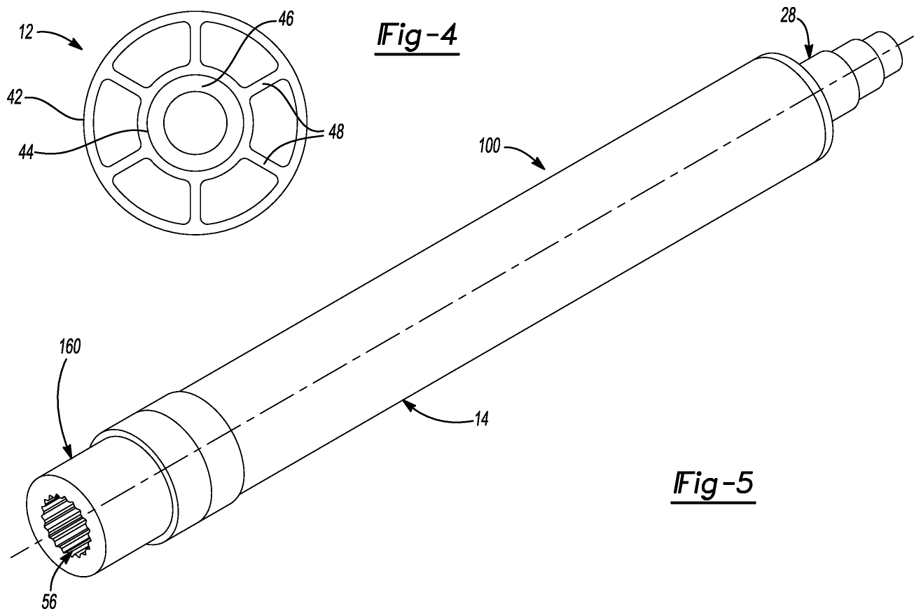

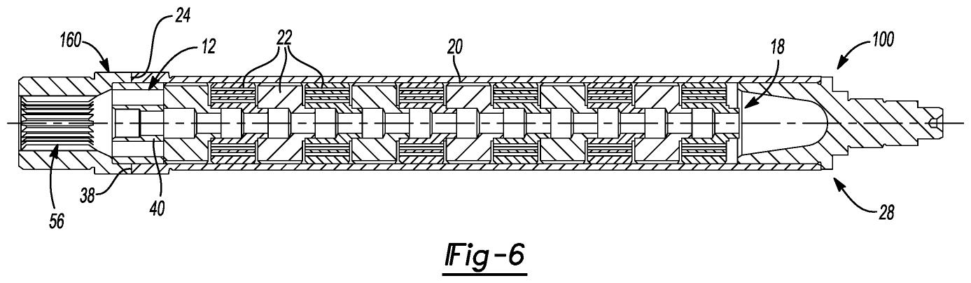

FIGS. 5 and 6 depict another implementation of an output shaft assembly 100. The output shaft assembly 100 includes the elongated tubular shaft 14 and an output coupling 160. The output coupling 160 includes a female splined fitting 56 that is configured to engage a transmission (not shown) that communicates rotational movement of the rotor in the rotating electrical machine to one or more drive wheels of a BEV.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A vehicular output shaft assembly, configured for a rotating electrical machine, comprising:
an elongated tubular shaft having a cavity at least partially defined by an inner diameter of the elongated tubular shaft and a shaft radial surface;
an output coupling having an inner diameter and a coupling radial surface; and
an integrated ring received within the cavity of the elongated tubular shaft and the inner diameter of the output coupling, wherein the integrated ring positions the shaft radial surface and the coupling radial surface to abut and the elongated tubular shaft and the output coupling are welded together between the shaft radial surface and the coupling radial surface.

2. The vehicular output shaft assembly recited in claim 1, wherein the output coupling includes a helical gear.

3. The vehicular output shaft assembly recited in claim 1, wherein the output coupling includes a female splined fitting.

4. The vehicular output shaft assembly recited in claim 1, wherein the output coupling comprises powdered metal.

5. The vehicular output shaft assembly recited in claim 1, wherein the elongated tubular shaft is formed from high-strength low-alloy (HSLA) steel.

6. The vehicular output shaft assembly recited in claim 1, wherein a weld path extends directly between the shaft radial surface and the coupling radial surface.

7. The vehicular output shaft assembly recited in claim 1, further comprising a bushing received by an inner diameter of the integrated ring.

8. The vehicular output shaft assembly recited in claim 7, further comprising a cooling tube received by the bushing.

9. The vehicular output shaft assembly recited in claim 7, further comprising a plurality of spokes between the inner diameter of the integrated ring and an outer diameter of the integrated ring.

10. The vehicular output shaft assembly recited in claim 1, further comprising a bearing cap inserted in a distal end of the elongated tubular shaft.

11. A vehicular output shaft assembly, configured for a rotating electrical machine, comprising:
an integrated ring having an outer surface configured to be received within a cavity of the elongated tubular shaft and an inner diameter of the output coupling, wherein the integrated ring positions a shaft radial surface and a coupling radial surface to abut facilitating a welded connection between the elongated tubular shaft and the output coupling between the shaft radial surface and the coupling radial surface.

12. The vehicular output shaft assembly recited in claim 11, wherein the integrated ring is formed from powdered metal.

13. The vehicular output shaft assembly recited in claim 11, further comprising a bushing received by an inner diameter of the integrated ring.

14. The vehicular output shaft assembly recited in claim 13, further comprising a cooling tube received by the bushing.

15. The vehicular output shaft assembly recited in claim 13, further comprising a plurality of spokes between the inner diameter of the integrated ring and an outer diameter of the integrated ring.
